(19) United States
(12) Patent Application Publication
(10) Pub. No.: US 2012/0255639 A1
(43) Pub. Date: Oct. 11, 2012

(54) SOLENOID VALVE

(75) Inventors: Hirofumi Onodera, Kariya-city (JP); Mitsuyuki Kobayashi, Gamagori-city (JP)

(73) Assignee: DENSO CORPORATION, Kariya-city (JP)

(21) Appl. No.: 13/438,874

(22) Filed: Apr. 4, 2012

(30) Foreign Application Priority Data
Apr. 6, 2011 (JP) 2011-84474

(51) Int. Cl. F16K 11/20

(52) U.S. Cl. 137/637

(57) ABSTRACT

First and second valve members are received in a valve receiving chamber, which is connected to an inlet passage and an outlet passage. First and second valve seats are annular and are formed at a connection of the valve receiving chamber to the outlet passage. The second valve member is lifted away from the second valve seat synchronously with lift movement of the first valve member upon energization of an electromagnetic drive arrangement when a force, which is determined based on an applied pressure force applied to the second valve member by a differential pressure between a pressure of the inlet passage and a pressure of the outlet passage and urging forces of the first and second urging members, is smaller than an electromagnetic attractive force.

### CROSS REFERENCE TO RELATED APPLICATION

This application is based on and incorporates herein by reference Japanese Patent Application No. 2011-84474 filed on Apr. 6, 2011.

### TECHNICAL FIELD

The present disclosure relates to a solenoid valve.

### BACKGROUND

A solenoid valve, which can switch between a small flow quantity and a large flow quantity, is known. For example, Japanese Unexamined Utility Model Publication JPH05-032888U teaches a current proportional control valve, which has two valve seats that are coaxially arranged in series. An upstream side valve is slid together with an electromagnetic drive arrangement. A downstream side valve is freely slideably relative to the electromagnetic drive arrangement. Opening of the downstream side valve is delayed from opening of the upstream side valve. In the state where the upstream side valve is opened while the downstream side valve is closed, a small flow quantity of fluid flows toward the downstream side through a bypass passage. In a state where the downstream side valve is opened, a medium to large flow quantity of fluid flows toward the downstream side in response to the amount of slide of the electromagnetic drive arrangement.

In a case of a tank sealing valve, which enables or disables communication between a fuel tank and a canister in a fuel vapor processing system of, for example, a vehicle, it is demanded to limit rapid outflow of fuel vapor from the fuel tank at the time of opening the tank sealing valve. In order to meet such a demand, the current proportional control valve of Japanese Unexamined Utility Model Publication JPH05-032888U, which changes the flow quantity depending on a degree of opening of the valve, may be used.

However, in the current proportional control valve of Japanese Unexamined Utility Model Publication JPH05-032888U, a current control circuit, which implements linear output or multistage output of the electric current, is required, and on/off control cannot be used to implement the required function. Furthermore, in the case where the current proportional control valve of Japanese Unexamined Utility Model Publication JPH05-032888U is used as the tank sealing valve, a pressure sensing device (pressure sensing means), which senses the pressure of the fuel tank, needs to be provided, and the drive current of the solenoid valve needs to be controlled according to the sensed pressure. Therefore, the apparatus is complicated and becomes expensive.

### SUMMARY

The present disclosure is made in view of the above disadvantages. According to the present disclosure, there is provided a solenoid valve, which includes a valve housing, a first valve member, a second valve member, a first urging member, a second urging member and an electromagnetic drive arrangement. The valve housing includes a valve receiving chamber, an inlet passage, an outlet passage, a first valve seat and a second valve seat. The inlet passage and the outlet passage open to the valve receiving chamber. The first valve seat is annular and is formed at a connection of the valve receiving chamber to the outlet passage. The second valve seat is annular and is formed around the first valve seat at the connection of the valve receiving chamber. The first valve member is received in the valve receiving chamber and is seatable against the first valve seat in a valve closing direction of the first valve member. The second valve member is received in the valve receiving chamber at a location radially outward of the first valve member and includes a communication passage, which communicates between the inlet passage and an intermediate chamber formed between the first valve member and the second valve member. The second valve member is seatable against the second valve seat in a valve closing direction of the second valve member when the second valve member is urged in the valve closing direction of the second valve member by a differential pressure between a pressure of the inlet passage and a pressure of the outlet passage, and the second valve member is liftable away from the second valve seat in a valve opening direction of the second valve member synchronously with lift movement of the first valve member when the first valve member is lifted away from the first valve seat in a valve opening direction of the first valve member beyond a predetermined switching position.

The first urging member urges the first valve member toward the first valve seat in the valve closing direction of the first valve member. The second urging member has one end, which contacts the second valve member, and the other end, which contacts a seat plate that is fixed to the first valve member. The second urging member urges the first valve member away from the first valve seat in the valve opening direction of the first valve member through the seat plate and also urges the second valve member toward the second valve seat in the valve closing direction of the second valve member. The electromagnetic drive arrangement drives the first valve member in the valve opening direction of the first valve member by an electromagnetic attractive force, which is generated by the electromagnetic drive arrangement upon energization of the electromagnetic drive arrangement. The first valve member and the second valve member are seated against the first valve seat and the second valve seat, respectively, when the electromagnetic drive arrangement is deenergized. The first valve member is lifted away from the first valve seat when the electromagnetic drive arrangement is energized. The second valve member is lifted away from the second valve seat in the valve opening direction of the second valve member synchronously with the lift movement of the first valve member upon the energization of the electromagnetic drive arrangement when a force, which is determined based on an applied pressure force applied to the second valve member by the differential pressure and urging forces of the first and second urging members, is smaller than the electromagnetic attractive force.

### BRIEF DESCRIPTION OF THE DRAWINGS

The drawings described herein are for illustration purposes only and are not intended to limit the scope of the present disclosure in any way.

FIG. 1A is a cross-sectional view of a solenoid valve in a full closing position according to a first embodiment of the present disclosure;

FIG. 1B is a partial enlarged view of FIG. 1A, showing a main feature of the solenoid valve;

FIG. 2 is a schematic diagram showing a structure of a fuel tank sealing system, in which the solenoid valve of the first embodiment is applied;

FIG. 3A is partial view showing a first valve member and a second valve member of the solenoid valve according to the first embodiment;

FIG. 3B is an end view taken in a direction of IIIB in FIG. 3A, showing the first valve member;

FIG. 3C is an end view taken in a direction of IIIC in FIG. 3A, showing the second valve member;

FIG. 4A is a cross-sectional view of the solenoid valve in a switching position according to the first embodiment;

FIG. 4B is a partial enlarged view of FIG. 4A, showing the main feature of the solenoid valve;

FIG. 5A is a cross-sectional view of a solenoid valve in a full opening position according to the first embodiment;

FIG. 5B is a partial enlarged view of FIG. 5A, showing a main feature of the solenoid valve;

FIG. 6 is a diagram for describing operations of the solenoid valve according to the first embodiment;

FIG. 7A is a partial cross-sectional view of a solenoid valve in a full closing position according to a second embodiment of the present disclosure;

FIG. 7B is a partial cross-sectional view of a solenoid valve in a full closing position according to a third embodiment of the present disclosure; and

FIG. 7C is a partial cross-sectional view of a solenoid valve in a full closing position according to a fourth embodiment of the present disclosure.

### DETAILED DESCRIPTION

Various embodiments of the present disclosure will be described with reference to the accompanying drawings.

### First Embodiment

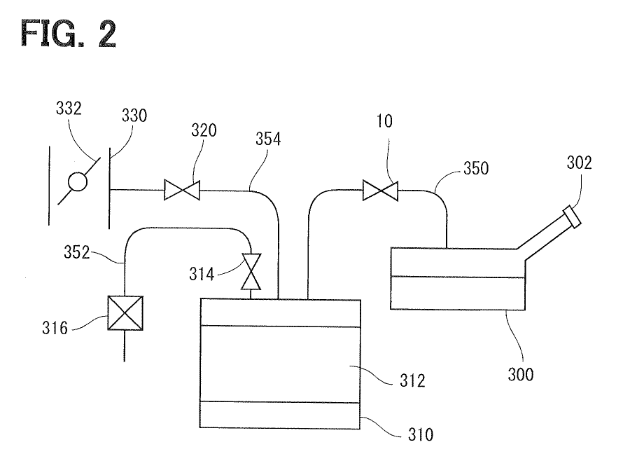

FIG. 2 shows a fuel tank sealing system, in which a solenoid valve of the first embodiment is applied. The fuel tank sealing system, which is a type of a fuel vapor processing system, is used in a vehicle having a hybrid engine system, in which one of an electric motor and an internal combustion engine is selected based on a driving state of the vehicle to provide a vehicle drive force.

The solenoid valve 10 is inserted into a conduit 350, which connects between a fuel tank 300 and a canister 310. The canister 310 receives an adsorbent material 312, which adsorbs fuel vapor generated at the fuel tank 300.

A solenoid valve 314 is inserted into a conduit 352, which is connected to the canister 310. When the solenoid valve 314 is opened, the canister 310 is opened to the atmosphere through the conduit 352. A filter 316 is provided in the conduit 352 on the atmosphere side of the solenoid valve 314.

A purge valve 320 is inserted into a conduit 354, which connects between the canister 310 and an intake pipe 330. When the purge valve 320 and the solenoid valve 314 are opened, the fuel vapor, which is adsorbed in the canister 310, is drawn from the canister 310 into the intake pipe 330 by a negative pressure, which is generated on a downstream side of a throttle valve 332 in the intake pipe 330.

However, in a state where the vehicle is driven by the electric motor, the negative pressure is not generated in the intake pipe 330, so that the fuel vapor, which is adsorbed in the canister 310, cannot be outputted into the intake pipe 330. At that time, the adsorbent material 312 of the canister 310 may possibly excessively adsorb the fuel vapor to cause overflow of the fuel vapor from the canister 310. In order to limit occurrence of such a situation, in the fuel tank sealing system, the solenoid valve 10, which is placed between the fuel tank 300 and the canister 310, is closed to seal the fuel tank 300.

Furthermore, in the fuel tank sealing system, at the time of supplying fuel into the fuel tank 300 at, for example, a gas station, when a driver of the vehicle manipulates a fuel supply inlet opening lever (not shown), an opening signal is outputted from an opening switch, which is provided to the fuel supply inlet opening lever, to an engine control unit (ECU). When the ECU receives the opening signal, the ECU opens the solenoid valve 10. Thus, the fuel tank 300 and the canister 310 are communicated with each other, and thereby the pressure of the fuel tank 300 is decreased to the atmospheric pressure. As a result, releasing of the fuel vapor from the fuel tank 300 to the atmosphere is limited at the time of removing a cap 302 of the fuel supply inlet to open the fuel supply inlet.

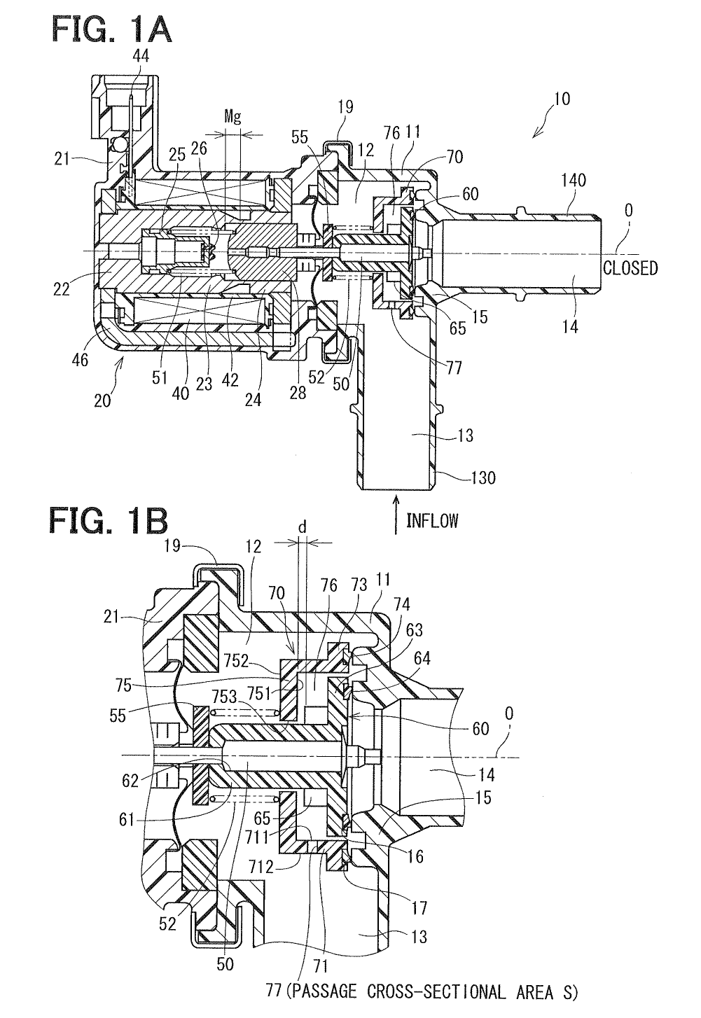

Next, the structure of the solenoid valve 10 will be described with reference to FIGS. 1A-1B and 3A-6.

As shown in FIGS. 1A and 1B, a valve housing 11 and a coil housing 21 form an outer shell of the solenoid valve 10. The valve housing 11 receives first and second valve members 60, 70 and forms a passage. The coil housing 21 receives an electromagnetic drive arrangement 20, which drives the valve members in a direction of a central axis O. The valve housing 11 and the coil housing 21 are fixed together by a clinched member 19.

An inlet tube 130, which forms an inlet passage 13, is formed in the valve housing 11. The inlet passage 13 extends in a direction perpendicular to the central axis O. Furthermore, an outlet tube 140, which forms an outlet passage 14, is formed in the valve housing 11. The outlet passage 14 extends along the central axis O. The inlet tube 130 is connected to the fuel tank 300, and the outlet tube 140 is connected to the canister 310.

The inlet passage 13 and the outlet passage 14 open to a valve receiving chamber (valve receiving portion) 12. At a connection of the valve receiving chamber 12 to the outlet passage 14, a first valve seat 16, which is configured into an annular form, is formed on a radially outer side of an opening of the outlet passage 14. Furthermore, in the connection of the valve receiving chamber 12, a second valve seat 17 is formed around the first valve seat 16 of the connection 15 on a radially outer side of the first valve seat 16 such that the second valve seat 17 is generally concentric to the first valve seat 16.

The first valve member 60 and the second valve member 70 are received in the valve receiving chamber 12.

The first valve member 60 includes a shaft portion 61 and a large diameter portion 63. A shaft hole 62, which receives a shaft 50, is formed in the shaft portion 61. A first contact portion 64 is formed in the large diameter portion 63. The first contact portion 64 is an annular protrusion, which protrudes from an end surface of the large diameter portion 63 and is opposed to the first valve seat 16 of the valve housing 11.

The first valve member 60 includes a plurality of engaging ribs 65, which are formed integrally with, i.e., are fixed to the first valve member 60. The engaging ribs 65 are located on a radially outer side of the shaft portion 61 and are arranged one after another at generally equal intervals in a circumferential direction. An end surface of each engaging rib 65, which is opposite from the large diameter portion 63 in the direction of the central axis O, is a planar surface that is generally perpendicular to the central axis O. These end surfaces of the engaging ribs 65 have generally the same axial height, which is measured from the large diameter portion 63 in the direction of the central axis O. The engaging ribs 65 limit deformation of the shaft portion 61 and the large diameter portion 63 and maintain a generally right angle intersection between the central axis O and the first contact portion 64. Furthermore, the planar end surfaces of the engaging ribs 65 can contact against a bottom portion inner wall 751 of the second valve member 70, which will be described later. In the present embodiment, the engaging ribs 65 serve as an engaging member(s) of the present disclosure.

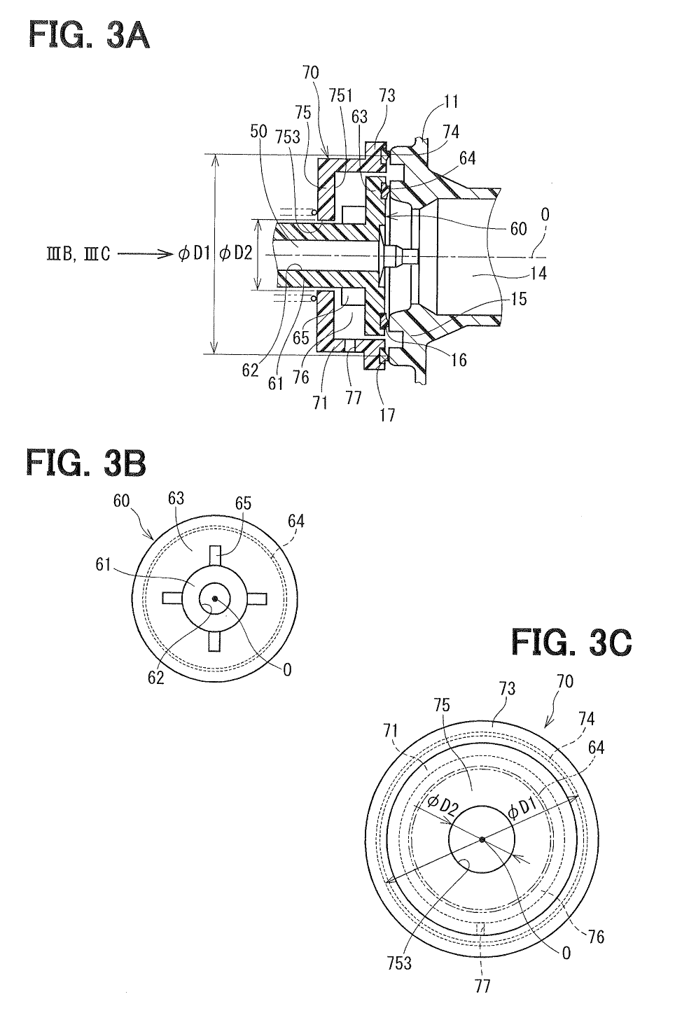

The second valve member 70 is configured into a cup-shaped body and includes a bottom portion 75, a tubular portion 71 and a flange portion 73. The second valve member 70 is coaxial with the first valve member 60 and is placed on a radially outer side of the first valve member 60. A receiving hole 753 is formed through a center part of the bottom portion 75 of the second valve member 70. An inner diameter of the tubular portion 71 is larger than an outer diameter of the large diameter portion 63 of the first valve member 60, and an inner diameter of the receiving hole 753 is larger than the outer diameter of the shaft portion 61 of the first valve member 60. A second contact portion 74 is formed in the flange portion 73 of the second valve member 70. The second contact portion 74 is an annular protrusion, which protrudes from an end surface of the flange portion 73 of the second valve member 70 and is opposed to the second valve seat 17 of the valve housing 11. After the assembling, the second contact portion 74 is placed concentrically with the first contact portion 64 (see FIG. 3C).

An intermediate chamber 76 is formed between the second valve member 70 and the first valve member 60. A communication passage 77 is formed in the tubular portion 71 to communicate between an inner wall 711 side and an outer wall 712 side of the tubular portion 71, i.e., to communicate between the intermediate chamber 76 and the inlet passage 13.

A pressure receiving surface area Sr is defined by the following equation (1) where D1 (indicated as φD1 in FIGS. 3A and 3C) is a diameter of the second contact portion 74, and D2 (indicated as φD2 in FIGS. 3A and 3C) is an inner diameter of the receiving hole 753, as indicated in FIGS. 3A and 3C.

Sr=(D1²−D2²)×π/4 Equation (1)

The pressure receiving surface area Sr is a surface area of the second valve member 70, on which a differential pressure ΔP between the pressure of the inlet passage 13 and the pressure of the outlet passage 14 is applied. A seat plate 55 is placed around the shaft 50 such that the seat plate 55 contacts (fixedly contacts) an end surface of the shaft portion 61 of the first valve member 60, which is located on a side where the electromagnetic drive arrangement 20 is located, so that the seat plate 55 is moved integrally with the first valve member 60. A second spring 52 is supported between the seat plate 55 and the outer wall 752 of the bottom portion 75. Thereby, the second spring 52, which serves as a second urging member, urges the first valve member 60 in a valve opening direction thereof and the second valve member 70 in a valve closing direction thereof.

The electromagnetic drive arrangement 20 includes a stationary core 22, a movable core 28, a first spring 51 and a coil 40. The stationary core 22 includes an attracting portion 23 and a receiving portion 24. The attracting portion 23 generates a magnetic attractive force between the stationary core 22 and the movable core 28. The receiving portion 24 receives the movable core 28 such that the movable core 28 is reciprocatable in the receiving portion 24. A thin wall portion is formed between the attracting portion 23 and the receiving portion 24 to limit magnetic short circuit between the attracting portion 23 and the receiving portion 24.

An engaging member 25 is provided in an inside of the attracting portion 23 of the stationary core 22. A stopper 26, which is made of rubber, is installed to a movable core 28 side end surface of the engaging member 25 to absorb collision shock of the movable core 28 at the time of occurrence of collision of the movable core 28 against the engaging member 25 caused by the magnetic attractive force.

One end of the first spring 51, which serves as a first urging member, is engaged to the engaging member 25, and the other end of the first spring 51 is engaged to the movable core 28. The first spring 51 urges the first valve member 60 in the valve closing direction through the movable core 28 and the shaft 50.

Here, the urging force of the first spring 51 is denoted by Fs1, and the urging force of the second spring 52 is denoted by Fs2. A resultant force (net force) of the urging force Fs1 of the first spring 51 in the valve closing direction of the first valve member 60 and the urging force Fs2 of the second spring 52 in the valve opening direction of the first valve member 60 will be referred to as a resultant spring force Fst (corresponding to a resultant urging force of the present disclosure).

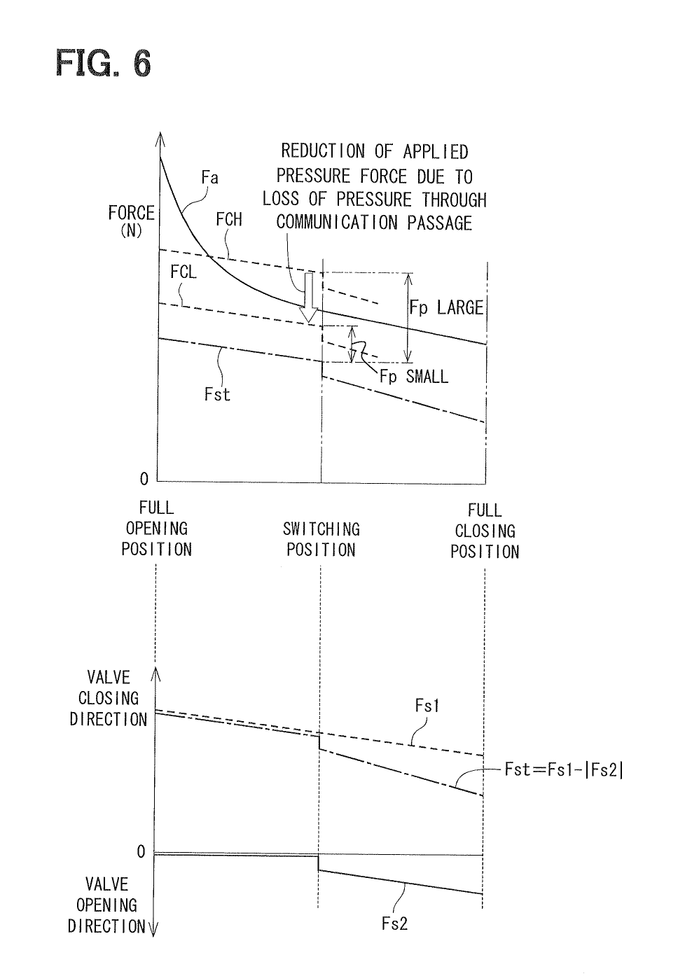

Here, for the descriptive purpose, it is assumed that the force in the valve closing direction is positive, and the force in the valve opening direction is negative. In such a case, the resultant spring force Fst is expressed by the following equation (2) as a force obtained by subtracting an absolute value of the urging force Fs2 of the second spring 52 from the urging force Fs1 of the first spring 51 (see FIG. 6).

Fst=Fs1−|Fs2| Equation (2)

The resultant spring force Fst is set to a value that does not cause opening of the first valve member 60 by a negative pressure when the pressure of the fuel tank 300 becomes the negative pressure during a deenergization period (turning off period) of the coil 40.

The coil 40, which is wound around a bobbin 42, is placed on a radially outer side of the stationary core 22. The terminals 44 are electrically connected to the coil 40 to supply a drive electric current to the coil 40. A yoke 46 is placed on a radially outer side of the coil 40 to form a magnetic circuit in cooperation with the attracting portion 23 and the receiving portion 24.

Next, operations of the solenoid valve 10 will be described with reference to FIGS. 1A-1B and 3A-6.

### (I) Full Closing Position

As shown in FIGS. 1A and 1B, when the coil 40 is deenergized, the movable core 28, the shaft 50, the seat plate 55 and the first valve member 60 are urged in the valve closing direction by the resultant spring force Fst. At this time, a magnetic gap Mg between the attracting portion 23 of the stationary core 22 and the movable core 28 is maximum. The first contact portion 64 of the first valve member 60 contacts against, i.e., is seated against the first valve seat 16 to close the communication between the inlet passage 13 and the outlet passage 14.

Furthermore, the pressure of the inlet passage 13 and the pressure of the intermediate chamber 76 are balanced by the communication passage 77, which is formed in the tubular portion 71 of the second valve member 70. Therefore, only the urging force Fs2 of the second spring 52 is exerted against the second valve member 70 in the valve closing direction, so that the second contact portion 74 of the second valve member 70 contacts against, i.e., is seated against the second valve seat 17.

(II) Change from Full Closing Position to Switching Position

In the fuel tank sealing system, at the time of supplying fuel to the fuel tank 300, the coil 40 is energized to open the solenoid valve 10.

When the coil 40 is energized (turned on), an electromagnetic attractive force Fa, which is larger than the resultant spring force Fst, is generated, so that the movable core 28 is attracted to the stationary core 22. Therefore, the magnetic gap Mg is reduced, and thereby the movable core 28 is attracted in the valve opening direction together with the shaft 50, the seat plate 55 and the first valve member 60.

As shown in FIG. 1B, a gap d is formed between the end surface of each engaging rib 65 of the first valve member 60 and the inner wall 751 of the bottom portion 75 of the second valve member 70. Therefore, the first valve member 60 can be moved through the distance, which corresponds to the gap d, without being restrained by the other member.

When the first valve member 60 is moved in the valve opening direction, the first contact portion 64 is moved away from the first valve seat 16. Thereby, a first valve opening passage 81 is formed between the first contact portion 64 and the first valve seat 16. Therefore, the inlet passage 13 and the outlet passage 14 are communicated with each other through the communication passage 77, the intermediate chamber 76 and the first valve opening passage 81. In this way, in the fuel tank sealing system, the fuel tank 300 and the canister 310 are communicated with each other. Thus, the releasing of the fuel vapor from the fuel tank 300 to the surrounding atmosphere through the fuel supply inlet is limited at the time of removing the cap 302 from the fuel supply inlet to open the same.

Now, there will be described the operation (behavior) at the time of moving the first valve member 60 (at the time of changing the lift amount of the first valve member 60) from the full closing position to the switching position (described later in detail). When the first valve member 60 is moved, i.e., lifted in the valve opening direction, the first spring 51 is compressed, so that the urging force Fs1 in the valve closing direction progressively increases. Furthermore, the second spring 52 is expanded, and thereby the urging force Fs2, which is exerted against the seat plate 55 in the valve opening direction, progressively decreases. Thus, the resultant spring force Fst progressively increases with a slope (rate), which is larger than that of the urging force Fs1 of the first spring 51 (see FIG. 6).

At this time, the inlet passage 13 and the outlet passage 14 are communicated with each other, so that a differential pressure ΔP, which is a difference between the pressure of the inlet passage 13 and the pressure of the outlet passage 14, is generated between the upstream side (inlet passage 13) side of the first valve opening passage 81 and the downstream side (outlet passage 14) side of the first valve opening passage 81. Here, a force, which is exerted against the pressure receiving surface area Sr of the second valve member 70 in the valve closing direction by the differential pressure ΔP, is referred to as an applied pressure force (also referred to as a received pressure force) Fp. In such a case, the second valve member 70 is urged in the valve closing direction by a resultant force (net force) of the urging force Fs2 of the second spring 52 and the applied pressure force Fp.

Next, there will be described the operation (behavior) at time of moving the first valve member 60 to the switching position (time of reaching the lift amount of the first valve member 60 to the lift amount at the switching position).

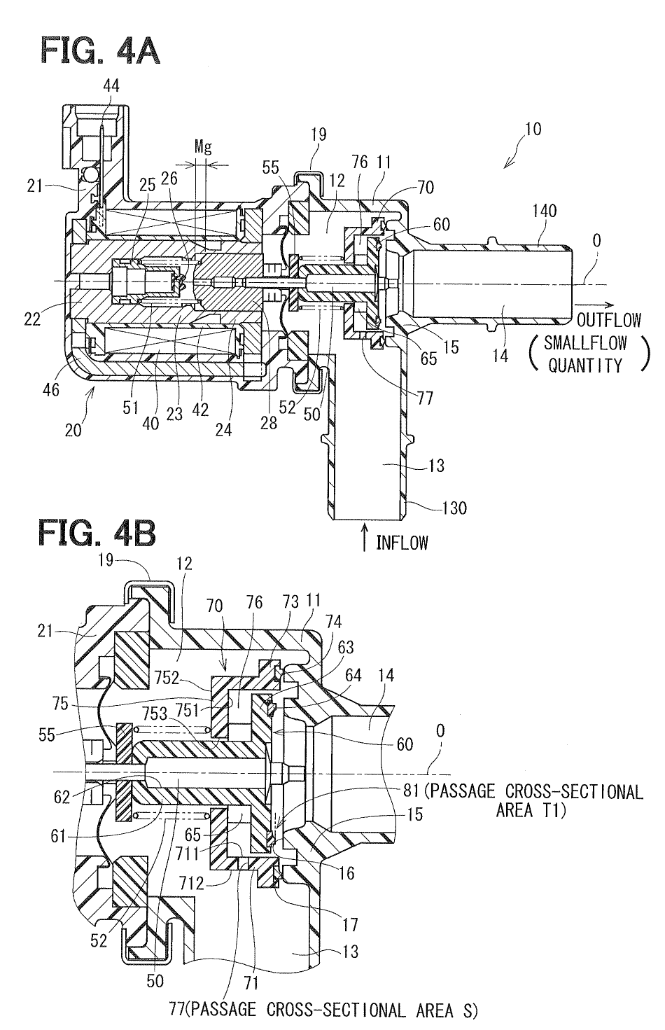

The switching position refers to a position of the first valve member 60, at which the gap d between the end surface of each engaging rib 65 of the first valve member 60 and the inner wall 751 of the bottom portion 75 of the second valve member 70 becomes zero, i.e., at which the end surface of the engaging rib 65 contacts the inner wall 751 of the bottom portion 75 of the second valve member 70, as shown in FIGS. 4A and 4B.

At the switching position, the movement of the first valve member 60 in the valve opening direction is restrained by the second valve member 70. That is, the first valve member 60 needs to be moved along with the second valve member 70 when the first valve member 60 is moved, i.e., lifted from the switching position to the full opening position. Therefore, in order to lift the first valve member 60 to the full opening position thereof along with the second valve member 70, a combined valve closing force FC, which is a resultant force (net force) of the resultant spring force Fst and the applied pressure force Fp, needs to be smaller than the electromagnetic attractive force Fa, which attracts the first valve member 60.

In a case where the applied pressure force Fp is relatively large, the combined valve closing force FC is referred to as the combined valve closing force FCH and is indicated by a corresponding dotted line in FIG. 6. Furthermore, in a case where the applied pressure force Fp is relatively small, the combined valve closing force FC is referred to as the combined valve closing force FCL and is indicated by a corresponding dotted line in FIG. 6.

In the case where the combined valve closing force FC is larger than the electromagnetic attractive force Fa (i.e., in the case of the combined valve closing force FCL), the first valve member 60 cannot be moved to the full opening position and is held in the switching position. Here, a passage cross-sectional area of the first valve opening passage 81 will be referred to as a passage cross-sectional area T1. The passage cross-sectional area T1 of the first valve opening passage 81 is set to be equal to or larger than a passage cross-sectional area S of the communication passage 77.

At the switching position, the first valve member 60 is opened, and the second valve member 70 is closed. In this state, the fuel vapor of the fuel tank 300 is conducted from the inlet passage 13 to the outlet passage 14 through the communication passage 77, the intermediate chamber 76 and the first valve opening passage 81, so that the pressure of the inlet passage 13 progressively decreases. Thus, due to the decrease in the differential pressure ΔP and thereby the decrease in the applied pressure force Fp, the combined valve closing force FC decreases.

The fuel vapor of the fuel tank 300 is outputted through the communication passage 77, which has the relatively small passage cross-sectional area as described later, until the combined valve closing force FC becomes equal to or smaller than the electromagnetic attractive force Fa. Therefore, the solenoid valve 10 functions as a small flow quantity valve, which limits the rapid output of the fuel vapor of the fuel tank 300 in the case where the differential pressure ΔP is relatively large.

(III) Change from Switching Position to Full Opening Position

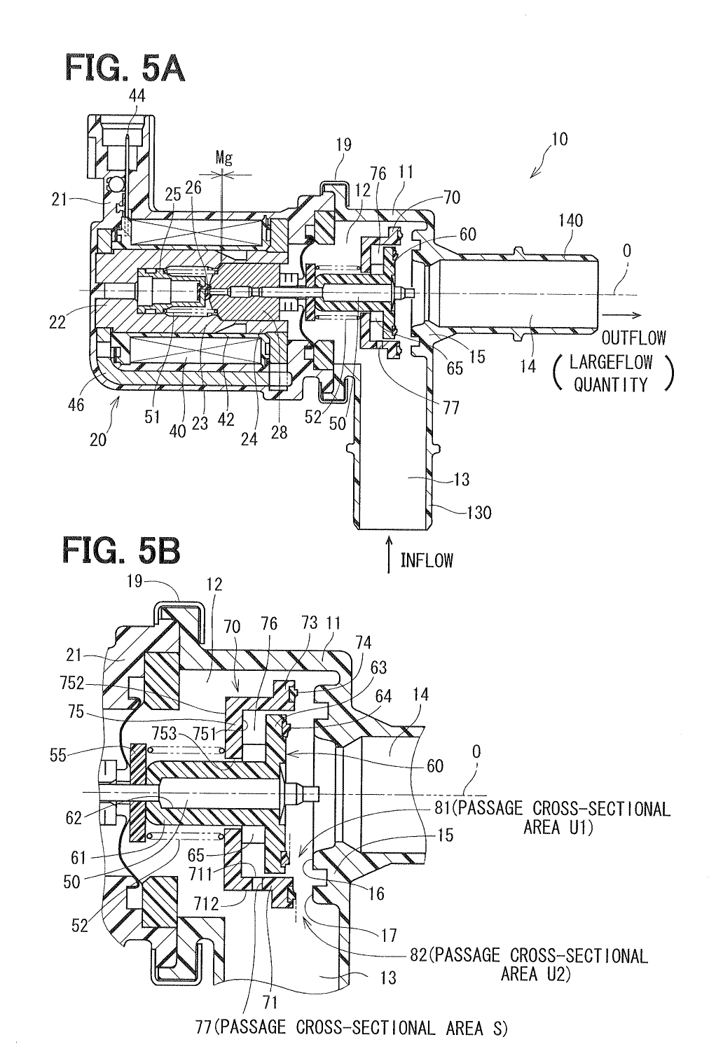

In a case where the combined valve closing force FC at the switching position becomes lower than the electromagnetic attractive force Fa due the result of the outflow of the fuel vapor, or the combined valve closing force FC at the switching position immediately after the valve opening of the first valve member 60 is smaller than the electromagnetic attractive force Fa (i.e. at the time of reaching the combined valve closing force FCL), the first valve member 60 is moved from the switching position (see FIGS. 4A and 4B) to the full opening position (see FIGS. 5A and 5B) along with the second valve member 70.

The second valve member 70 is moved away from the second valve seat 17, and thereby a second valve opening passage 82 is formed between the second contact portion 74 and the second valve seat 17. Therefore, the inlet passage 13 and the outlet passage 14 are communicated with each other through the second valve opening passage 82 and the first valve opening passage 81.

At this time, the first spring 51 is further compressed, so that the urging force Fs1 in the valve closing direction progressively increases. Furthermore, the second spring 52 is not compressed or expanded, so that the urging force Fs2 against the first valve member 60 becomes zero. Thus, the resultant spring force Fst becomes equal to the urging force of the first spring 51 (see FIG. 6).

When the magnetic gap Mg between the attracting portion 23 of the stationary core 22 and the movable core 28 decreases, the electromagnetic attractive force Fa rapidly increases. Thereby, the valve opening movement of the first valve member 60 and the valve opening movement of the second valve member 70 are accelerated. Then, the positions of the first and second valve members 60, 70 shown in FIGS. 5A and 5B become the full opening positions of the first and second valve members 60, 70.

Here, a passage cross-sectional area of the first valve opening passage 81 at the full opening position of the first valve member 60 is referred to as a passage cross-sectional area U1, and a passage cross-sectional area of the second valve opening passage 82 at the full opening position of the second valve member 70 is referred to as a passage cross-sectional area U2. The passage cross-sectional area U1 of the first valve opening passage 81 at the full opening position of the first valve member 60 is larger than the passage cross-sectional area T1 of the first valve opening passage 81 at the switching position of the first valve member 60.

Furthermore, each of the passage cross-sectional area U1 of the first valve opening passage 81 at the full opening position of the first valve member 60 and the passage cross-sectional area U2 of the second valve opening passage 82 at the full opening position of the second valve member 70 is set to be larger than the passage cross-sectional area S of the communication passage 77. Each of the passage cross-sectional areas U1, U2 is defined as a value, which is obtained by multiplying a circumferential length of the valve opening passage 81, 82 by an axial lift length of the valve member 60, 70 (i.e., an axial distance between the valve member 60, 70 and the valve seat 16, 17). Therefore, in the case where the diameter of the first contact portion 64 and the diameter of the second contact portion 74 are sufficiently larger than the hole diameter (passage diameter) of the communication passage 77, the passage cross-sectional areas U1, U2 become larger than the passage cross-sectional area S of the communication passage 77.

Therefore, at the full opening position, the fuel vapor of the fuel tank 300 is outputted through the passage, which has the passage cross-sectional area larger than the passage cross-sectional area at the switching position. That is, the solenoid valve 10 functions as a large flow quantity valve when the second valve member 70 is opened in the state where the differential pressure ΔP is relatively small.

As discussed above, although the solenoid valve 10 is the solenoid valve, which is on/off controlled, the solenoid valve 10 functions as the small flow quantity valve in the state, in which the differential pressure ΔP between the pressure of the inlet passage 13 and the pressure of the outlet passage 14 is relatively large, and functions as the large flow quantity valve in the state, in which the differential pressure ΔP between the pressure of the inlet passage 13 and the pressure of the outlet passage 14 is relatively small. Thereby, in the fuel tank sealing system, at the time of opening the solenoid valve 10, the rapid output of the fuel vapor from the fuel tank 300 can be limited in the high pressure state of the fuel tank 300 (i.e., the state where the pressure of the fuel tank 300 is relatively high) immediately after the valve opening of the solenoid valve 10, and then the fuel vapor can be rapidly outputted from the fuel tank 300 upon decreasing of the pressure of the fuel tank 300 equal to or lower than a predetermined value.

As discussed above, the solenoid valve 10 of the present embodiment does not require a pressure sensing device (pressure sensing means), which senses the pressure of the fuel tank. Furthermore, the switching of the flow quantity of the solenoid valve 10 between the two states (small flow quantity and the large flow quantity) through the on/off control of the solenoid valve 10 can be achieved with the simple structure.

Furthermore, according to the present embodiment, the engaging ribs 65 are formed integrally in the first valve member 60. Therefore, according to the first embodiment, the number of the components of the first valve member 60 can be reduced in comparison to a case where a separate engaging member is provided separately from the first valve member 60 to implement the function of the engaging ribs 65 like in the case of the following second embodiment. Furthermore, a step of joining the engaging member to the first valve member 60 can be eliminated according to the first embodiment.

### Second Embodiment

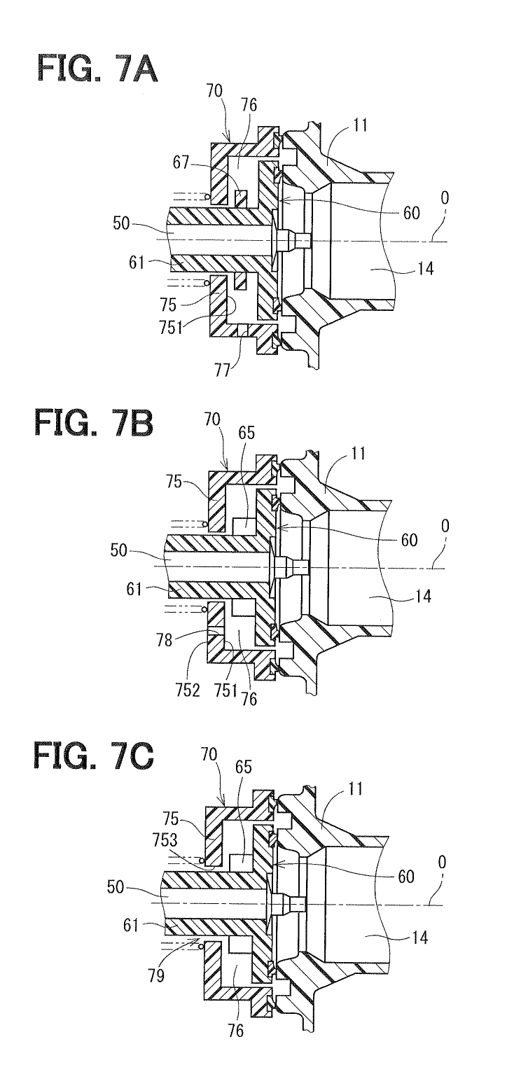

In the second embodiment shown in FIG. 7A, in place of the engaging ribs 65 of the first valve member 60 of the first embodiment, an engaging member 67, which is configured into an annular form, is provided separately from the first valve member 60. The engaging member 67 is joined to, i.e., is fixed to the outer wall of the shaft portion 61 of the first valve member 60 by press-fitting, fusing, welding or the like. The engaging member 67 is reciprocated together with the first valve member 60. When the lift amount of the first valve member 60 exceeds the switching position, the engaging member 67 is engaged with the bottom portion inner wall 751 of the second valve member 70 to open, i.e., lift the second valve member 70.

For example, in a case where the solenoid valve 10 is applied to different types of apparatuses, it is conceivable that the setting of the switching position needs to be changed for each type of apparatus. Also, it is conceivable that the design modification of the switching position needs to be made according the required specification. In such cases, when the engaging member 67 is manufactured separately from the first valve member 60, it is possible to use the same first valve member 60 for the different types of the apparatuses while changing the shape of the engaging member 67. Alternatively, the same engaging member 67 and the same first valve member 60 may be used for the different types of apparatuses by merely changing the joining position of the engaging member 67 relative to the first valve member 60.

### Third and Fourth Embodiments

In the third embodiment shown in FIG. 7B and the fourth embodiment shown in FIG. 7C, the location of the communication passage is different from that of the first embodiment. Specifically, in the third embodiment of FIG. 7B, a communication passage 78 communicates between the inner wall 751 side (the intermediate chamber 76) of the bottom portion 75 of the second valve member 70 and the outer wall 752 side of the bottom portion 75 of the second valve member 70. In the fourth embodiment of FIG. 7C, a clearance between the inner wall of the receiving hole 753 of the second valve member 70 and the outer wall of the shaft portion 61 of the first valve member 60 forms a communication passage 79. Here, when the engaging ribs 65 of the first valve member 60 contact the bottom portion inner wall 751 of the second valve member 70, the inner wall 751 side of the bottom portion 75 and the outer wall 752 side of the bottom portion 75 can be communicated with each other through each circumferential portion, which is defined between corresponding circumferentially adjacent two of the engaging ribs 65.

In a case where the second valve member 70 is formed by resin molding, the communication passage 78, 79 is formed to extend in a removing direction of a molding die in each of the third and fourth embodiments. Therefore, the structure of the molding die can be simplified.

Now, modifications of the above embodiments will be described.

(A) The number and shape of the engaging ribs 65 of the first valve member 60 of the first embodiment as well as the shape of the engaging member 67 of the second embodiment are not limited to the above described ones and may be appropriately modified to any other ones as long as the engaging ribs 65 or the engaging member 67 can engage the second valve member 70 at the switching position.

(B) Different from the above embodiments, the passage cross-sectional area S of the communication passage 77 may be made larger than at least one of the passage cross-sectional area U1 of the first valve opening passage 81 at the full opening position of the first valve member 60 and the passage cross-sectional area U2 of the second valve opening passage 82 at the full opening position of the second valve member 70.

(C) The second spring is not limited to the compression spring of the above embodiments. For example, the second spring may be an extension spring, which connects between the bottom portion inner wall 751 of the second valve member 70 and the first valve member 60 and is placed in the intermediate chamber 76.

(D) The application of the solenoid valve of the present disclosure is not limited to the tank sealing valve of the above embodiments. For example, the solenoid valve of the present disclosure may be applied as another type of valve that controls the passing flow quantity of fluid in two stages, i.e., that reduces the passing flow quantity of fluid in the state, in which the pressure different between the pressure of the inlet passage and the pressure of the outlet passage is equal to or larger than the predetermined threshold value, and increase the passing flow quantity of fluid in the state, in which the pressure different between the pressure of the inlet passage and the pressure of the outlet passage is smaller than the predetermined threshold value.

As discussed above, the present disclosure is not limited the above embodiments and modifications thereof. That is, the above embodiments and modifications thereof may be modified in various ways without departing from the spirit and scope of the disclosure.

What is claimed is:

1. A solenoid valve comprising:
a valve housing that includes:
a valve receiving chamber;
an inlet passage and an outlet passage, which open to the valve receiving chamber;
a first valve seat, which is annular and is formed at a connection of the valve receiving chamber to the outlet passage; and
a second valve seat, which is annular and is formed around the first valve seat at the connection of the valve receiving chamber;
a first valve member that is received in the valve receiving chamber and is seatable against the first valve seat in a valve closing direction of the first valve member;
a second valve member that is received in the valve receiving chamber at a location radially outward of the first valve member and includes a communication passage, which communicates between the inlet passage and an intermediate chamber formed between the first valve member and the second valve member, wherein the second valve member is seatable against the second valve seat in a valve closing direction of the second valve member when the second valve member is urged in the valve closing direction of the second valve member by a differential pressure between a pressure of the inlet passage and a pressure of the outlet passage, and the second valve member is liftable away from the second valve seat in a valve opening direction of the second valve member synchronously with lift movement of the first valve member when the first valve member is lifted away from the first valve seat in a valve opening direction of the first valve member beyond a predetermined switching position;
a first urging member that urges the first valve member toward the first valve seat in the valve closing direction of the first valve member;
a second urging member that has one end, which contacts the second valve member, and the other end, which contacts a seat plate that is fixed to the first valve member, wherein the second urging member urges the first valve member away from the first valve seat in the valve opening direction of the first valve member through the seat plate and also urges the second valve member toward the second valve seat in the valve closing direction of the second valve member; and
an electromagnetic drive arrangement that drives the first valve member in the valve opening direction of the first valve member by an electromagnetic attractive force, which is generated by the electromagnetic drive arrangement upon energization of the electromagnetic drive arrangement, wherein:
the first valve member and the second valve member are seated against the first valve seat and the second valve seat, respectively, when the electromagnetic drive arrangement is deenergized;
the first valve member is lifted away from the first valve seat when the electromagnetic drive arrangement is energized; and
the second valve member is lifted away from the second valve seat in the valve opening direction of the second valve member synchronously with the lift movement of the first valve member upon the energization of the electromagnetic drive arrangement when a force, which is determined based on an applied pressure force applied to the second valve member by the differential pressure and urging forces of the first and second urging members, is smaller than the electromagnetic attractive force.

2. The solenoid valve according to claim 1, wherein:
when the electromagnetic drive arrangement is deenergized, the first valve member is seated against the first valve seat in the valve closing direction of the first valve member by a resultant urging force, which is a resultant force of the urging force of the first urging member in the valve closing direction of the first valve member and the urging force of the second urging member in the valve opening direction of the first valve member, while the second valve member is seated against the second valve seat in the valve closing direction of the second valve member by the urging force of the second urging member in the valve closing direction of the second valve member;
when the electromagnetic drive arrangement is energized, the first valve member is lifted to the switching position away from the first valve seat in the valve opening direction of the first valve member;
when a combined valve closing force, which is a resultant force of the resultant urging force and the applied pressure force applied to the second valve member by the differential pressure, is equal to or larger than the electromagnetic attractive force upon placement of the first valve member in the switching position through the energization of the electromagnetic drive arrangement, the second valve member is seated against the second valve seat, and the inlet passage and the outlet passage are communicated with each other through the communication passage of the second valve member and the intermediate chamber; and
when the combined valve closing force is smaller than the electromagnetic attractive force upon the placement of the first valve member in the switching position through the energization of the electromagnetic drive arrangement, the second valve member is lifted to a full opening position of the second valve member away from the second valve seat in the valve opening direction of the second valve member synchronously with the lift movement of the first valve member, and the inlet passage and the outlet passage are communicated with each other through a second valve opening passage, which is formed between the second valve member and the second valve seat, and a first valve opening passage, which is formed between the first valve member and the first valve seat.

3. The solenoid valve according to claim 2, wherein each of a passage cross-sectional area of the first valve opening passage and a passage cross-sectional area of the second valve opening passage is larger than a passage cross-sectional area of the communication passage when the second valve member is placed in the full opening position.

4. The solenoid valve according to claim 1, wherein:
the second valve member is configured into a cup-shaped body; and
the first valve member is received in and is reciprocatable relative to the second valve member.

5. The solenoid valve according to claim 1, wherein a member that determines the switching position of the first valve member is an engaging member, which is fixed to the first valve member and contacts a bottom portion inner wall of the second valve member at a time of lifting of the second valve member together with the first valve member.

6. The solenoid valve according to claim 5, wherein the engaging member is formed integrally with the first valve member.
